(19) United States
(12) Patent Application Publication
(10) Pub. No.: US 2009/0308003 A1
(43) Pub. Date: Dec. 17, 2009

(54) SWIMMING POOL STAIRS

(76) Inventors: Bernard Juneau, Quebec (CA); Marc Jacques, Quebec (CA); Alain Gauthier, Lac Beauport (CA)

Correspondence Address: OGILVY RENAULT LLP, 1, Place Ville Marie, SUITE 2500, MONTREAL, QC, H3B 1R1, CA

(21) Appl. No.: 12/140,327

(22) Filed: Jun. 17, 2008

(51) Int. Cl. E04F 11/04; E06C 7/18

(52) U.S. Cl. 52/184; 182/106

(57) ABSTRACT

There is described a stair system insertable into a pool having a top edge surface and bottom surface, comprising a stair portion defining steps and risers each having a fixed height, the stair portion having a support portion projecting from an uppermost one of the risers and adapted to be seated against the top edge surface of the pool, and a ballasted booster positioned below the stair portion at any one of given locations in the bottom of the stair portion and lying against the bottom surface of the pool. The stair system has a height adjustable by the position of the booster with respect to the bottom of the stair portion as a function of the height between the top edge surface and the bottom of the pool.

### TECHNICAL FIELD

The present object generally relates to swimming pools and, more particularly, to stairs and other accessories used in swimming pools.

### BACKGROUND OF THE INVENTION

Various stair and step systems have been created for swimming pools. Normally, installation of nonpermanent stairs in a pool requires the user to get into the water once the stairs have been placed in the pool. A ballast is then installed on the stair system in order to maintain the stairs in place. For example, in cooler climates, the installation of the stairs each beginning of the summer season becomes an unpleasant experience especially if the water of the pool is not heated. In addition, the stairs that are commercialized are not adaptable to the majority of pools and present some security risk for children.

Multiple stair systems have been described in the prior art. U.S. Pat. No. 6,966,405 disclose a stair system having a bottomless hollow body with a ballast receiving portion for receiving a ballast to stabilize the stair portion once installed in the pool.

U.S. Pat. Nos. 5,644,873 and 6,966,405 also disclose stair systems adaptable to various installations. Specifically, the stair system taught in U.S. Pat. No. 5,644,873 does not require any mechanical fastening of the structure. However, several ballast or bags need to be inserted manually into the structure once the structure has been sunk into the pool.

U.S. Pat. No. 6,966,405 teaches a stair system having L-shaped connectors enabling attachment to the pool walls. Still, a user needs to add a ballast to the stair system described in U.S. Pat. No. 6,966,405.

### SUMMARY OF THE APPLICATION

It is therefore an aim of the present application to provide a novel swimming pool stair system.

In accordance with the present disclosure there is now provided a stair system insertable into a pool having a top edge surface and bottom surface, said stair system comprising: a stair portion defining steps and risers each having a fixed height, the stair portion having a support portion projecting from an uppermost one of the risers and adapted to be seated against the top edge surface of the pool, and a ballasted booster positioned below the stair portion at any one of given locations in the bottom of the stair portion and lying against the bottom surface of the pool, whereby the stair system has a height adjustable by the position of the booster with respect to the bottom of the stair portion as a function of the height between the top edge surface and the bottom of the pool.

### BRIEF DESCRIPTION OF THE DRAWINGS

FIG. 1 illustrates an exploded view of a swimming pool stair system in accordance with a first embodiment of the present application;

FIG. 2 is a front perspective view of the swimming pool stair system of FIG. 1;

FIG. 3 is a back perspective view of the swimming pool stair system of FIG. 1;

FIG. 4 is an elevational view of the swimming pool stair system of FIG. 1;

FIG. 5 is a side elevational view of the swimming pool stair system of FIG. 1;

FIG. 6 is a rear elevational view of the swimming pool stair system of FIG. 1;

FIG. 7 is top plan view of the swimming pool stair system of FIG. 1; and

FIG. 8 is an enlarged perspective view of the back portion of the stair portion of the swimming pool stair system of FIG. 1.

### DETAILED DESCRIPTION OF THE PREFERRED EMBODIMENT

The present disclosure provides a swimming pool stair system adapted to be installed on pools of various heights, such as aboveground pools. For example, typical sidewalls of aboveground pools have heights of 48, 52 or 54 inches.

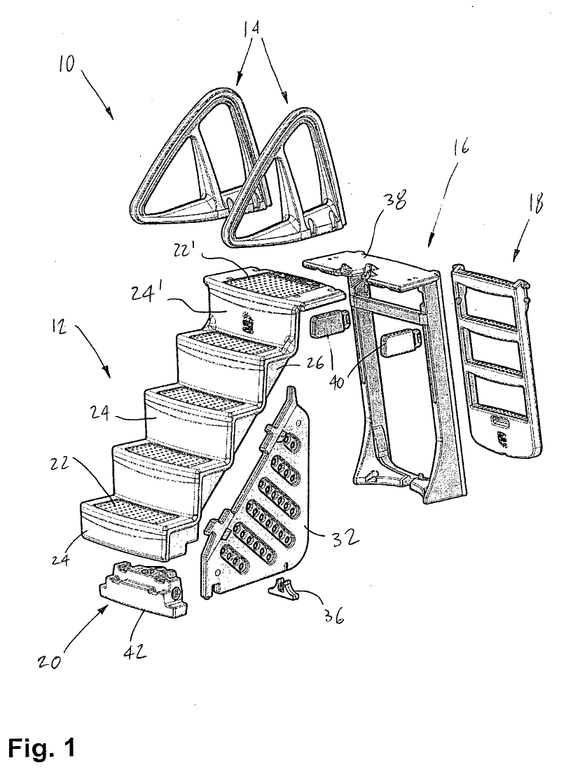

Referring to the drawings, and more particularly to FIG. 1, a swimming pool stair system described herein is generally shown at 10. The swimming pool stair system 10 is adapted to be used with in-ground and aboveground pools. The stair system 10 has a stair portion 12 and is connected to handrails 14 and a ladder structure 16 supporting a ladder portion 18. In its aboveground configuration, the stair system 10 has the structure 16 and the ladder portion 18. In its in-ground configuration or in its deck configuration, the stair system 10 does not necessarily include these parts.

The stair system 10 also comprises a ballasted booster 20 inserted below the bottommost one of the steps 22. Preferably, the stair system 10 described herein is made of a material resistant to salt degradation and to degradation caused by products used for maintaining the pH of the pool. The stair system 10 is also UV-resistant.

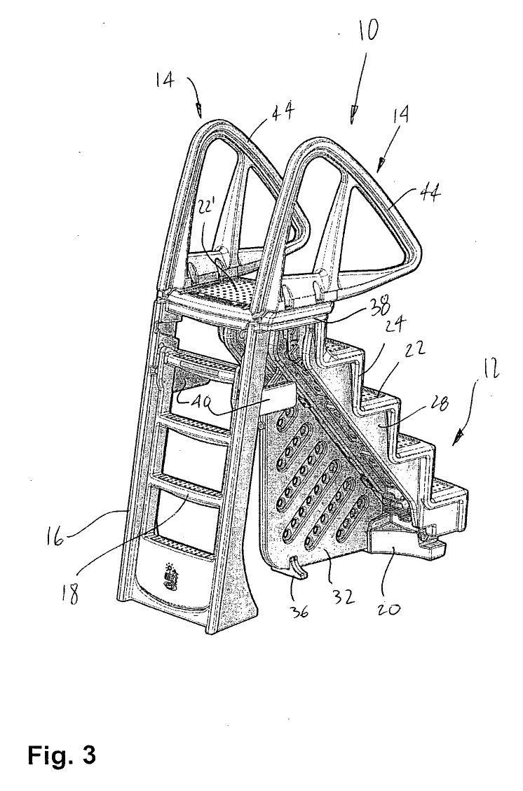

The stair portion 12 illustrated in FIG. 1 is shown having five steps 22 which are separated by risers 24. Preferably, the steps 22 have an anti-skid surface consisting, for example, of small protuberances that are moulded on the steps 22. An abrasive such as sand bonded to the anti-skid surface is preferably also provided. Sidewalls 26 and 28 (illustrated in FIG. 3) complete the shape of the stair portion 12. More preferably, a light is fitted in one of the risers 24.

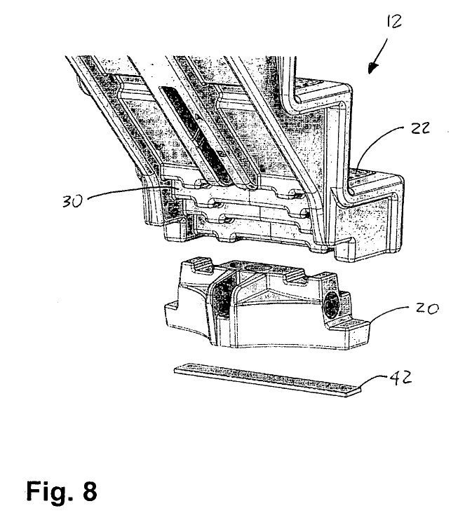

The ballasted booster 20 is incrementally inserted and fixed below the bottommost one of the steps 22 in order to adjust the height of the stair portion 12 between a height of 52 and 54 inches. As seen in FIG. 8, the booster 20 is inserted into complementary recesses 30 found in the rear face of the stair portion 12. A floor mat 42 is inserted below the booster 20. The floor mat 42 is in contact with the bottom of the pool and provides friction between the booster 20 and the bottom of the pool, and prevents damage to the bottom of the pool.

The insertion of the booster 20 into a complementary recess 30 depending on the height of the pool not only incrementally adjusts the height of the stair portion 12, but also permits that uppermost riser 24′ to always have the same height as all the other risers 24. When a user is entering a pool using the stair system 10 as described herein, the first step or stride taken by the user from the top edge of the pool or from a deck, for example, is of the same length as all subsequent steps or strides until reaching the bottom of the pool.

Consequently, because of this configuration, there is no variation between the height of the uppermost riser 24′ and the height of the subsequent risers 24. The stair portion 12 described herein is ergonomic since the uppermost riser 24′ is always the same height as all the other risers 24. Commercially available stair systems have a first step with a higher or lower height compared to the other steps. When a user enters the water, the first step is often bigger or smaller than the subsequent steps in order to get to the bottom of the pool, and this increases the risks of incidents.

The swimming pool stair system 10 described herein provides a system wherein all the steps taken by a user are equal in length, which allows a user to make regular and consistent steps when entering the water. Because the first step, which is usually taken outside of the water, has the same height as the second step taken when entering the water level which usually reaches at most the second riser 24 from the top edge of the pool, it prevents injuries caused by variation in the length of steps taken by the user. On the other hand, the distance between the bottommost step 22 and the bottom of the pool may be more or less than the height of the risers 24 and 24′, but at least the swimmer is supported by the inertia of water and buoyancy forces.

As illustrated in FIG. 1, in an embodiment, a safety wall 32 is connected to the back portion of the stair portion 12. When using such stair system 10 as described therein, the presence of the safety wall 32 prevents children from passing behind the stair portion 12 in the water. Consequently, the safety wall 32 prevents accidental events such as a child being caught behind the stair portion 12 or the collapse of the stair portion 12 on a child when swimming. The safety wall 32 is advantageously shaped to be releasably connected in a corresponding cavity in the back portion of the stair portion 12 and is easily installed on or removed from the stair portion 12, thereby facilitating the installation and the displacement of the stair portion 12 in the pool. The safety wall 32 is slid on the upper edge of the pool when installing or removing the stair portion 12 in or from the pool.

In an embodiment, the safety wall 32 is positioned behind the stair portion 12 prior to inserting the stairs into the swimming pool. The safety wall 32 is also secured to the back portion of the stair portion 12 with fastener means such as straps or screws. A stand support 36 is provided for supporting the safety wall 32 on the floor of the pool.

In the prior art, sandbags are used as ballasts, as the stair portions usually define inner cavities with a support surface for such sandbags. In addition, a removable ballast compartment has also been described in the prior art wherein weights or sandbags are inserted.

On the contrary, no more underwater dives to pull sandbags from behind the steps are needed with the stair system 10 disclosed herein, since the booster 20 is manufactured with a weight sufficient to maintain the stair system 10 in the water when inserted and fixed below the bottommost one of the steps 22. Consequently, the stair portion 12 described herein will easily be maneuverable in the water, yet be heavy enough to sink to the bottom of the pool.

As best seen in FIG. 1, the transportation aspect is improved by the configuration of the present stair system 10, as all the components are separated from each other. Transportation and packaging costs are greatly reduced as the individual pieces are preferably included in a single box.

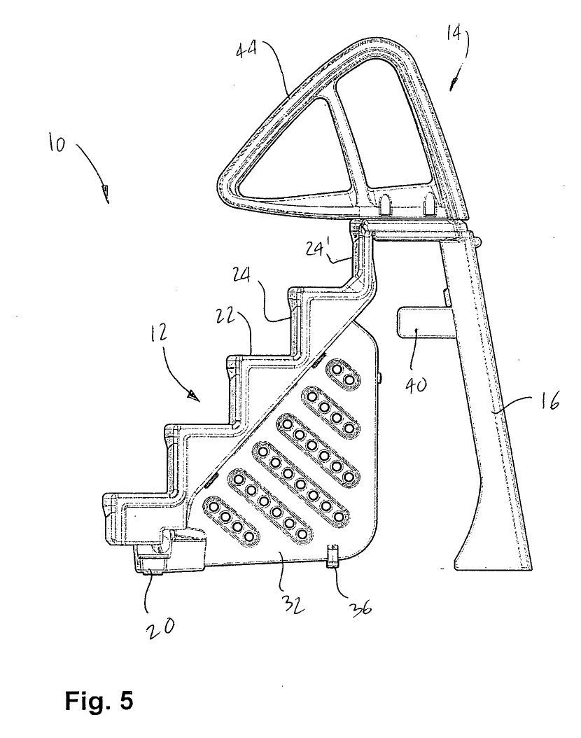

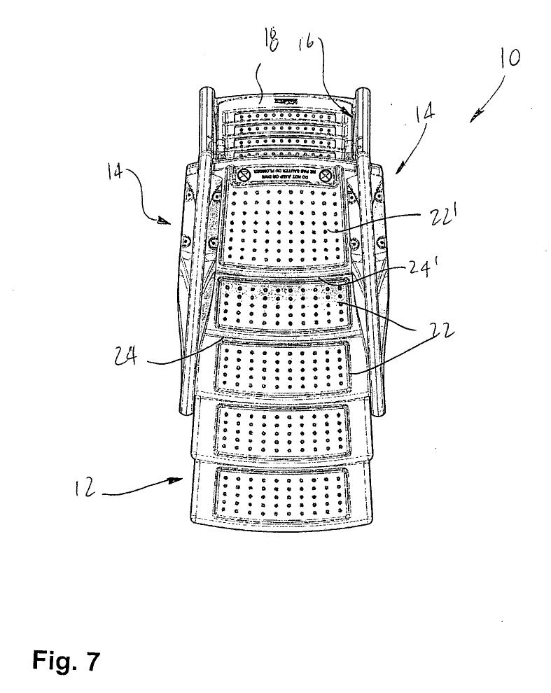

In a preferred embodiment, and as seen in FIGS. 1, 2, 3, 5 and 7, the uppermost step 22′ of the stair portion 12 is placed over the top panel 38 of the ladder structure 16 when the ladder portion 18 is used with an aboveground pool. The handrails 14 are placed over the uppermost step 22′ of the stair portion 12. The stair portion 12 is releasably connected to ladder structure 16 and to the handrails 14 with typical fasteners such as screws.

Lateral supports 40 are inserted into corresponding cavities in the ladder structure 16. These lateral supports 40 support the ladder structure 16 against the sidewalls of the aboveground pool and eliminate any potential collapsing of the ladder structure 16 on the sidewalls of the aboveground pool. The ladder portion 18 is positioned in the ladder structure 16, allowing climbing by the user in order to get to the uppermost step 22′ of the stair portion 12.

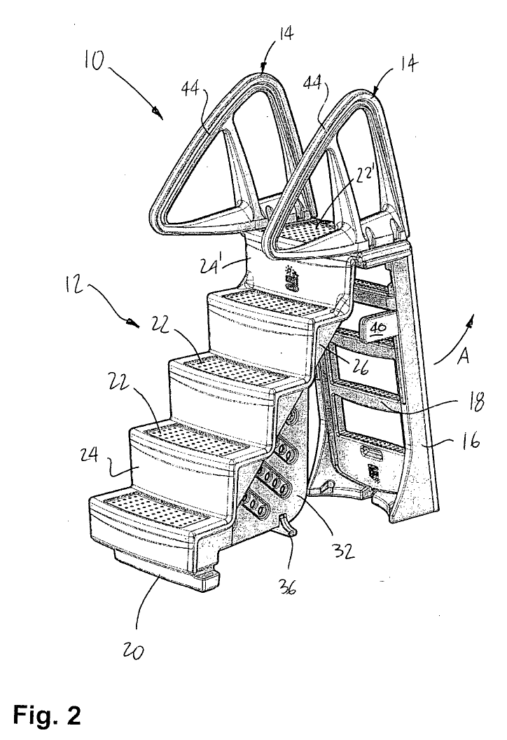

The ladder portion 18 is pivotally connected to the ladder structure 16. As shown by the arrow A in FIG. 2, the ladder portion 18B is pivotable from a lower stand position to an upper stand position. In the upper stand position, a user, such as a child, will not have access to the stair portion 12 by climbing the ladder portion 18. A locking mechanism is also provided to lock the ladder portion 18 to the ladder structure 16 in the upper stand position.

In an alternative embodiment, the stair system 10 disclosed herewith is used with an aboveground pool with a deck or an in-ground pool without the addition of the ladder structure 16 and the ladder portion 18. The handrails 14 are placed over or beside the uppermost stair 22′ of the stair portion 12. The stair portion 12 and the handrails 14 are releasably connected to the top edge of the aboveground pool with typical fasteners such as screws.

Alternatively, if the stair portion 12 needs to be removed from the water, as for example just before winter, and the handrails 14 are left attached to the top edge of the pool, the handrails 14 and stair portion 12 are independently fixed to the deck or the upper edge of the pool.

In an alternate embodiment, the stair portion 12 has a pair of support portions projecting from the uppermost riser, with the support portions seated directly on the top edge surface of the pool. This configuration does not comprise the uppermost stair 22′, but rather uses the top edge surface of the toll (e.g., such as a deck surrounding the in-ground pool), as the uppermost step. In this configuration, the risers are again of equal height.

For removing the stair portion 12 from the water, a user only removes the fasteners to unfix the handrails 14 and/or the stair portion 12 from the deck, sidewall of the pool or upper edge of the pool. Once the fasteners are removed, the user can pull the stair portion 12 by pulling the handrails 14, or the stair portion 12 directly in an upwardly movement away from the pool, sliding the safety wall 32 connected to the stair portion 12 against the upper edge of the pool in order to remove the stair portion 12 from the water.

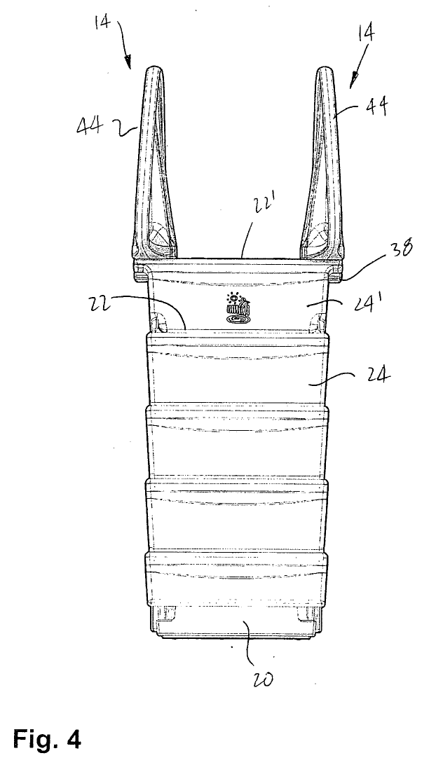

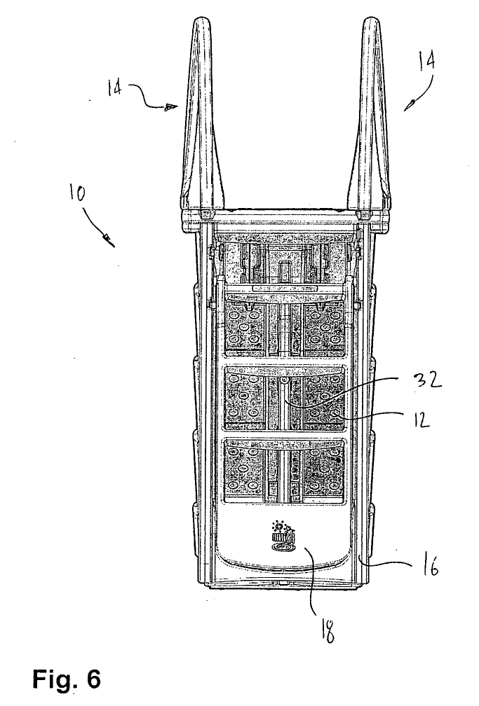

In FIGS. 2-7, the handrails 14, with a handle portion 44, are shown both connected to the top ends or uppermost step 22′ of the stair portion 12.

While the object has been described with particular reference to the illustrated embodiment, it will be understood that numerous modifications thereto will appear to those skilled in the art. Accordingly, the above description and accompanying drawings should be taken as illustrative of the invention and not in a limiting sense.

While the object has been described in connection with specific embodiments thereof, it will be understood that it is capable of further modifications, and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. A stair system insertable into a pool having a top edge surface and bottom surface, said stair system comprising:
a stair portion defining steps and risers each having a fixed height, the stair portion having a support portion projecting from an uppermost one of the risers and adapted to be seated against the top edge surface of the pool, and
a ballasted booster positioned below the stair portion at any one of given locations in the bottom of the stair portion and lying against the bottom surface of the pool,
whereby the stair system has a height adjustable by the position of the booster with respect to the bottom of the stair portion as a function of the height between the top edge surface and the bottom of the pool.

2. The stair system according to claim 1, wherein the support portion is an uppermost step.

3. The stair system according to claim 2, further comprising a safety wall releasably connected to a back portion of the stair portion.

4. The stair system according to claim 3, wherein the safety wall has holes therethrough.

5. The stair system according to claim 4, further comprising a stand support for supporting the safety wall on the bottom of the pool.

6. The stair system according to claim 2, wherein the uppermost step of the stair portion is seated directly on the top edge surface of the pool.

7. The stair system according to claim 2, further comprising at least one handrail having a handle portion.

8. The stair system according to claim 7, wherein the at least one handrail is connectable to the uppermost step of the stair portion.

9. The stair system according to claim 7, wherein the at least one handrail is connectable to the top edge surface of the pool.

10. The stair system according to claim 9, wherein the at least one handrail and the uppermost step of the stair portion are independently connectable to the top edge surface of the pool.

11. The stair system according to claim 7, further comprising a ladder structure and a ladder portion, said ladder portion being pivotally connected to the ladder structure, the ladder portion pivoting from a lower stand position to an upper stand position.

12. The stair system according to claim 11, wherein said ladder structure has a top panel connectable to the top edge surface of the pool.

13. The stair system according to claim 12, wherein the at least one handrail is connectable to the uppermost step of the stair portion and the uppermost step of the stair portion is seated on the top panel of the ladder structure.

14. The stair system according to claim 12, wherein the at least one handrail is independently connectable to the top edge surface of the pool and the uppermost step of the stair portion is connectable to the top panel of the ladder structure.

15. The stair system according to claim 12, further comprising lateral supports connected to the ladder structure, said lateral supports allowing the ladder structure to abut against the sidewalls of the pool.

16. The stair system according to claim 11, further comprising a locking mechanism to lock the ladder portion to the ladder structure in the upper stand position.

17. The stair system according to claim 1, further comprising a resilient member insertable under the booster.
